(19) United States
(12) Patent Application Publication
(10) Pub. No.: US 2008/0075951 A1
(43) Pub. Date: Mar. 27, 2008

(54) FLUOROACRYLATES AND HARDCOAT COMPOSITIONS INCLUDING THE SAME

(75) Inventors: Zai-Ming Qiu, Woodbury, MN (US); Naiyong Jing, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/535,731

(22) Filed: Sep. 27, 2006

(51) Int. Cl. B32B 27/30; B32B 27/26

(52) U.S. Cl. 428/336; 428/421; 428/522; 525/326.3

(57) ABSTRACT

Fluoroacrylate additives and hardcoat compositions including the same. The hardcoats can be particularly useful as a hardcoat layer on protective films or optical displays. Methods of forming the hardcoat layer from the hardcoat composition.

### BACKGROUND OF THE INVENTION

Optical hard coats are applied to optical display surfaces to protect them from scratching and marking. Desirable product features in optical hard coats include durability to scratches and abrasions, and resistance to inks and stains.

Materials that have been used to date for surface protection include fluorinated polymers, or fluoropolymers. Fluoropolymers provide advantages over conventional hydrocarbon based materials in terms of high chemical inertness (solvent, acid, and base resistance), dirt and stain resistance (due to low surface energy), low moisture absorption, and resistance to weather and solar conditions.

Fluoropolymers have also been investigated that are crosslinked to a hydrocarbon-based hard coating formulation that improves hardness and interfacial adhesion to a substrate. For example, it is known that free-radically curable perfluoropolyethers provide good repellency to inks from pens and permanent markers when added to ceramer hard coat compositions, which comprise a plurality of inorganic oxide particles and a free-radically curable binder precursor, such as described in U.S. Pat. No. 6,238,798 to Kang, and assigned to 3M Innovative Properties Company of St. Paul, Minn.

Industry would find advantage in further fluoropolymer hard coatings, particularly those having low fluorine content and still have desirable properties.

### SUMMARY OF THE INVENTION

The invention includes a hardcoat composition that includes i) at least one non-fluorinated crosslinking agent, ii) at least one compound having the formula:

R^{f3}-J-OC(O)NH—K—HNC(O)O—(C_{b}H_{2b})CH₍₃₋ᵥ₎((C_{y}H_{2y})OC(O)C(R⁸)═CH₂)ᵥ (Formula 1)

wherein, R^{f3} is a monovalent perfluoroalkyl group or a polyfluoroalkyl group which can be linear, branched, or cyclic. Exemplary R^{f3} includes, but is not limited to, CₑF₂ₑ₊₁—, wherein e is 1 to 8; CF₃CF₂CF₂CHFCF₂—; CF₃CHFO(CF₂)₃—; (CF₃)₂NCF₂CF₂—; CF₃CF₂CF₂OCF₂CF₂—; CF₃CF₂CF₂OCHCF₂—; n-C₃F₇OCF(CF₃)—; H(CF₂CF₂)₂—; or n-C₃F₇OCF(CF₃)CF₂OCF₂—.

J is a divalent linkage group, selected from, but not limited to,

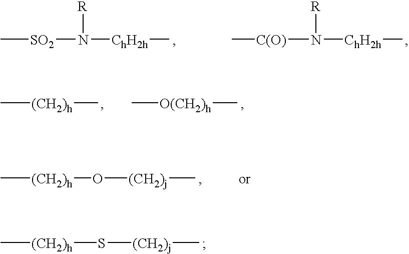

wherein R is H or an alkyl group of 1 to 4 carbon atoms;
h is 2 to 8;
j is 1 to 5;

K is the residue of a diisocyanate with an unbranched symmetric alkylene group, arylene group, or aralkylene group. Exemplary K includes, but is not limited to, —(CH₂)₆—,

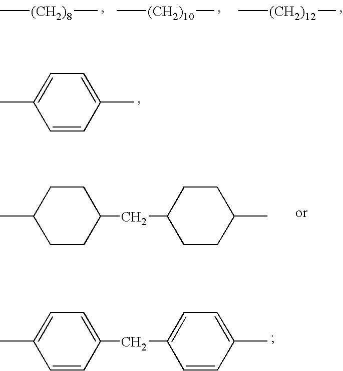

b is 1 to 30;

v is 1 to 3;

y is 0 to 6; and

R⁸ is H, CH₃, or F.

The invention also includes hardcoat compositions as above, wherein the fluoroacrylate additive is C₄F₉SO₂N(CH₃)C₂H₄O—C(O)NHC₆H₅CH₂C₆H₅NHC(O)—OC₂H₄OC(O)CH═CH₂ (MeFBSE-MDI-HEA), C₄F₉SO₂N(CH₃)C₂H₄O—C(O)NH(CH₂)₆NHC(O)—OC₂H₄OC(O)Me═CH₂ (MeFBSE-HDI-HEMA), C₄F₉SO₂N(CH₃)C₂H₄O—C(O)NH(CH₂)₆NHC(O)—OC₄H₈OC(O)CH═CH₂ (MeFBSE-HDI-BA), C₄F₉SO₂N(CH₃)C₂H₄O—C(O)NH(CH₂)₆NHC(O)—OC₁₂H₂₄OC(O)CH═CH₂ (MeFBSE-HDI-DDA), CF₃CH₂O—C(O)NHC₆H₅CH₂C₆H₅NHC(O)—OC₂H₄OC(O)CH═CH₂ (CF₃CH₂OH-MDI-HEA), C₄F₉CH₂CH₂O—C(O)NHC₆H₅CH₂C₆H₅NHC(O)—OC₂H₄OC(O)CH═CH₂ (C₄F₉CH₂CH₂OH-MDI-HEA), C₆F₁₃CH₂CH₂O—C(O)NHC₆H₅CH₂C₆H₅NHC(O)—OC₂H₄OC(O)CH═CH₂(C₆F₁₃CH₂CH₂OH-MDI-HEA), C₃F₇CHFCF₂CH₂O—C(O)NHC₆H₅CH₂C₆H₅NHC(O)—OC₂H₄OC(O)CH═CH₂(C₃F₇CHFCF₂CH₂OH-MDI-HEA), CF₃CHFO(CF₂)₃CH₂O—C(O)NHC₆H₅CH₂C₆H₅NHC(O)—OC₂H₄OC(O)CH═CH₂(CF₃CHFO(CF₂)₃CH₂O-MDI-HEA), C₃F₇OCHFCF₂CH₂O—C(O)NHC₆H₅CH₂C₆H₅NHC(O)—OC₂H₄OC(O)CH═CH₂(C₃F₇OCHFCF₂CH₂OH-MDI-HEA), C₃F₇OCF(CF₃)CH₂O—C(O)NHC₆H₅CH₂C₆H₅NHC(O)—OC₂H₄OC(O)CH═CH₂(C₃F₇OCF(CF₃)CH₂OH-MDI-HEA), C₄F₉SO₂NMeC₂H₄O—C(O)NHC₆H₄CH₂C₆H₄NHC(O)—OCH₂C(CH₂OC(O)CH═CH₂)₃ (MeFBSE-MDI-(SR-444C)), or combinations thereof.

The invention also includes a protective hardcoat article including a substrate having a hardcoat layer that includes the reaction product of a hardcoat composition. The invention further includes a protective film including a film or multilayer film having a hardcoat layer that includes the reaction product of a hardcoat composition. The invention further includes an optical display having an optical substrate having a hardcoat layer that includes the reaction product of a hardcoat composition.

### BRIEF DESCRIPTION OF THE DRAWINGS

FIG. 1 illustrates an article having a hard coated optical display formed in accordance with an embodiment of the present invention.

### DETAILED DESCRIPTION

For the following defined terms, these definitions shall be applied, unless a different definition is given in the claims or elsewhere in the specification.

The term “(meth)acryl” refers to functional groups including acrylates, methacrylates, acrylamides, methacrylamides, alpha-fluoroacrylates, thioacrylates and thio-methacrylates. An exemplary (meth)acryl group is acrylate.

The term “ceramer” is a composition having inorganic oxide particles, e.g. silica, typically of nanometer dimensions dispersed in a binder matrix. The phrase “ceramer composition” is meant to indicate a ceramer formulation in accordance with the present invention that has not been at least partially cured with radiation energy, and thus is a flowing, coatable liquid. The phrase “ceramer composite” or “coating layer” is meant to indicate a ceramer formulation in accordance with the present invention that has been at least partially cured with radiation energy, so that it is a substantially non-flowing solid. Additionally, the phrase “free-radically polymerizable” refers to the ability of monomers, oligomers, polymers or the like to participate in crosslinking reactions upon exposure to a suitable source of free radicals.

The term “polymer” will be understood to include polymers, copolymers (e.g. polymers using two or more different monomers), oligomers and combinations thereof, as well as polymers, oligomers, or copolymers that can be formed in a miscible blend.

As used herein, “symmetric diisocyanates” are diisocyanates that meet the three elements of symmetry as defined by Hawley's Condensed Chemical Dictionary 1067 (1997). First, they have a center of symmetry, around which the constituent atoms are located in an ordered arrangement. There is only one such center in the molecule, which may or may not be an atom. Second, they have a plane of symmetry, which divides the molecule into mirror-image segments. Third, they have axes of symmetry, which can be represented by lines passing through the center of symmetry. If the molecule is rotated, it will have the same position in space more than once in a complete 360° turn.

As used herein, the term “unbranched” means that the symmetric diisocyanate does not contain any subordinate chains of one or more carbon atoms.

As used herein, a “hardcoat composition” refers to a composition that is capable of forming a hardcoat layer after curing. The term “hard resin” or “hardcoat” means that the resulting cured polymer exhibits an elongation at break of less than 50 or 40 or 30 or 20 or 10 or 5 percent when evaluated according to the ASTM D-882-91 procedure. In some embodiments, the hard resin polymer can exhibit a tensile modulus of greater than 100 kpsi (6.89×10⁸ pascals) when evaluated according to the ASTM D-882-91 procedure. In some embodiments, the hard resin polymer can exhibit a haze value of less than 10% or less than 5% when tested in a Taber abrader according to ASTM D 1044-99 under a load of 500 g and 50 cycles (haze can be measured with Haze-Gard Plus, BYK-Gardner, MD, haze meter).

As used in the context of the hardcoat composition, a “weight percent” or of a particular component refers to the amount (by weight) of the particular component in the hardcoat composition after the solvent has been removed from the hardcoat composition but before the hardcoat composition has been cured to form the hardcoat layer.

As used in this specification and the appended claims, the singular forms “a”, “an”, and “the” include plural referents unless the content clearly indicates otherwise. Thus, for example, reference to a composition containing “a compound” includes a mixture of two or more compounds. As used in this specification and the appended claims, the term “or” is generally employed in its sense including “and/or” unless the content clearly dictates otherwise.

Unless otherwise indicated, all numbers expressing quantities of ingredients, measurements of properties such as contact angle, and so like as used in the specification and claims understood to be modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should be at least be construed in light of the number of reported significant digits and by applying ordinary rounding techniques. Notwithstanding that the numerical ranges and parameters set forth in the broad scope of the invention are approximations, the numerical values set forth in the specific examples are reported as accurately as possible. Any numerical value, however, inherently contains certain errors necessarily resulting from the standard deviations found in their respective testing measurements.

The term “optical display”, or “display panel”, can refer to any conventional optical displays, including but not limited to multi-character multi-line displays such as liquid crystal displays (“LCDs”), plasma displays, front and rear projection displays, cathode ray tubes (“CRTs”), and signage, as well as single-character or binary displays such as light emitting diodes (“LEDs”), signal lamps, and switches. The exposed surface of such display panels may be referred to as a “lens.” The invention is particularly useful for displays having a viewing surface that is susceptible to being touched or contacted by ink pens, markers and other marking devices, wiping cloths, paper items and the like.

The hardcoats of the invention can be employed in a variety of portable and non-portable information display articles. These articles include PDAs, cell phones (including combination PDA/cell phones), LCD televisions (direct lit and edge lit), touch sensitive screens, wrist watches, car navigation systems, global positioning systems, depth finders, calculators, electronic books, CD and DVD players, projection television screens, computer monitors, notebook computer displays, instrument gauges, instrument panel covers, signage such as graphic displays and the like. The viewing surfaces can have any conventional size and shape and can be planar or non-planar, an example of which is flat panel displays. The coating composition or coated film, can be employed on a variety of other articles as well such as for example camera lenses, eyeglass lenses, binocular lenses, mirrors, retroreflective sheeting, automobile windows, building windows, train windows, boat windows, aircraft windows, vehicle headlamps and taillights, display cases, road pavement markers (e.g. raised) and pavement marking tapes, overhead projectors, stereo cabinet doors, stereo covers, watch covers, as well as optical and magneto-optical recording disks, and the like.

A combination of low surface energy (e.g. anti-soiling, stain resistant, oil and/or water repellency) and durability (e.g. abrasion resistance) is desired for a coating layer for these displays while maintaining optical clarity. The hardcoat layer can function to decrease glare while improving durability and optical clarity.

The surface energy can be characterized by various methods such as contact angle and ink repellency. Exemplary methods of determining contact angle, durability, and other characterisitics are described in the Examples. In this application, “stain repellent” refers to a surface treatment exhibiting a static contact angle with water of at least 70 degrees. In one embodiment, the water contact angle is at least 80 degrees and in another at least 90 degrees. Alternatively, or in addition thereto, the advancing contact angle with hexadecane is at least 50 degrees and in another embodiment at least 60 degrees. Low surface energy results in anti-soiling and stain repellent properties as well as rendering the exposed surface easy to clean.

Another indicator of low surface energy relates to the extent to which ink from a pen or marker beads up when applied to the exposed surface. The surface layer and articles exhibit “ink repellency” when ink from pens and markers beads up into discrete droplets and can be easily removed by wiping the exposed surface with tissues or paper towels, such as tissues available from the Kimberly Clark Corporation, Roswell, Ga. under the trade designation “SURPASS FACIAL TISSUE.” Durability can be defined in terms of results from the combination of solvent resistance test and Steel Wool scratching resistance test as described in Examples.

Coatings appropriate for use as optical hardcoat layers must be substantially free of visual defects. Visual defects that may be observed include but are not limited to pock marks, fisheyes, mottle, lumps or substantial waviness, or other visual indicators known to one of ordinary skill in the art in the optics and coating fields. Thus, a “rough” surface as described in the Experimental section has one or more of these characteristics, and may be indicative of a coating material in which one or more components of the composition are incompatible with each other. Conversely, a substantially smooth coating, characterized below as “smooth” for the purpose of the present invention, presumes to have a coating composition in which the various components, in the reacted final state, form a coating in which the components are compatible or have been modified to be compatible with one another and further has little, if any, of the characteristics of a “rough” surface.

Additionally, the hardcoat layer can exhibit an initial haze of less than 2% and/or an initial transmission of at least 90%.

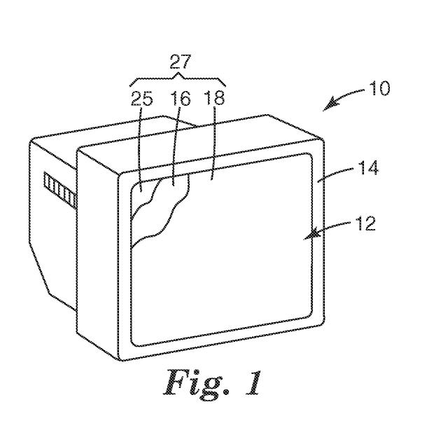

Referring now to FIG. 1, a perspective view of an article (here a computer monitor 10) is illustrated as having an optical display 12 coupled within a housing 14. The optical display 12 is a substantially transparent material having optically enhancing properties through which a user can view text, graphics, or other displayed information. The optical display 12 includes hardcoat layer 18 applied to an optical substrate 16. The thickness of the hardcoat layer is typically at least 0.5 microns, in one embodiment at least 1 micron, and in another embodiment at least 2 microns. The thickness of the hardcoat layer is generally no greater than 25 microns. In one embodiment the thickness ranges from 3 microns to 5 microns.

In another embodiment (not shown), the hardcoat layer described herein (i.e. comprising at least one fluoroacrylate additive and at least one non-fluorinated crosslinking agent) may be provided as an outermost hardcoat surface layer having an additional hard coat layer underlying the outermost hardcoat surface layer. In this embodiment, the additional hardcoat layer underlying the outermost hardcoat surface layer can have a thickness that is generally not more than 25 micrometers. In one embodiment, the additional hardcoat layer has a thickness from 3 to 5 micrometers.

Various permanent and removable grade adhesive compositions may be coated on the opposite side of the substrate 16 (i.e. to that of the hardcoat layer 18) so the article can be easily mounted to a display surface. Suitable adhesive compositions include but are not limited to (e.g. hydrogenated) block copolymers such as those commercially available from Kraton Polymers of Westhollow, Tex. under the trade designation “Kraton G-1657”, as well as other (e.g. similar) thermoplastic rubbers. Other exemplary adhesives include acrylic-based, urethane-based, silicone-based, and epoxy-based adhesives. In one embodiment, adhesives with sufficient optical quality and light stability are utilized so that the adhesive does not yellow with time or upon weather exposure so as to degrade the viewing quality of the optical display.

In one embodiment, a pressure sensitive adhesive (PSA) is utilized. The Pressure-Sensitive Tape Council has defined pressure sensitive adhesives as material with the following properties: (1) aggressive and permanent tack, (2) adherence with no more than finger pressure, (3) sufficient ability to hold onto an adherand, (4) sufficient cohesive strength, and (5) requires no activation by an energy source. PSAs are normally tacky at assembly temperatures, which is typically room temperature or greater (i.e., about 20° C. to about 30° C. or greater). Materials that have been found to function well as PSAs are polymers designed and formulated to exhibit the requisite viscoelastic properties resulting in a desired balance of tack, peel adhesion, and shear holding power at the assembly temperature. The most commonly used polymers for preparing PSAs are natural rubber-, synthetic rubber- (e.g., styrene/butadiene copolymers (SBR) and styrene/isoprene/styrene (SIS) block copolymers), silicone elastomer-, poly alpha-olefin-, and various (meth)acrylate- (e.g., acrylate and methacrylate) based polymers. Of these, (meth)acrylate-based polymer PSAs have evolved as a preferred class of PSA for the present invention due to their optical clarity, permanence of properties over time (aging stability), and versatility of adhesion levels, to name just a few of their benefits.

The adhesive can be applied using a variety of known coating techniques such as transfer coating, knife coating, spin coating, die coating and the like. Exemplary adhesives are described in U.S. Patent Application Publication No. 2003/0012936. Several of such adhesives are commercially available from 3M Company, St. Paul, Minn. under the trade designations 8141, 8142, and 8161.

The substrate 16 may include any of a wide variety of materials, including but not limited to, non-polymeric materials, such as glass, or polymeric materials, such as polyethylene terephthalate (PET), bisphenol A polycarbonate, cellulose triacetate, poly(methyl methacrylate), and biaxially oriented polypropylene which are commonly used in various optical devices. The substrate may also include polyamides, polyimides, phenolic resins, polystyrene, styrene-acrylonitrile copolymers, epoxies, and the like. The hardcoat of the invention can also be used on optical substrates; optical substrates, as used herein include, but are not limited to transparent substrates, transmissive substrates, microstructured substrates, and multilayer film substrates.

Typically the substrate will be chosen based in part on the desired optical and mechanical properties for the intended use. For example, substrates can be chosen with various optical properties, including, but not limited to light transmission, light reflectance, and opaqueness. Mechanical properties typically will include flexibility, dimensional stability and impact resistance. The substrate thickness typically also will depend on the intended use. For most applications, substrate thicknesses of less than 0.5 mm can be utilized, and in other embodiments, the substrate thickness is from 0.02 to 0.2 mm. In one embodiment self-supporting polymeric films are utilized as the substrate. The polymeric material can be formed into a film using conventional filmmaking techniques such as by extrusion and optional uniaxial or biaxial orientation of the extruded film. The substrate can be treated to improve adhesion between the substrate and the hardcoat layer, e.g., chemical treatment, corona treatment such as air or nitrogen corona, plasma, flame, or actinic radiation. If desired, an optional tie layer or primer can be applied to the substrate and/or hardcoat layer to increase the interlayer adhesion. The substrate can also be a previously coated article having various kinds of layers already coated thereon.

In the case of display panels, the substrate 16 is light transmissive, meaning light can be transmitted through the substrate 16 such that the display can be viewed. Both transparent (e.g. gloss) and matte light transmissive substrates 16 can be employed in display panels 10. Matte substrates 16 typically have lower transmission and higher haze values than typical gloss films. The matte films exhibit this specular property typically due to the presence of micron size dispersed inorganic fillers such as silica that diffuse light. Exemplary matte films are commercially available from U.S.A. Kimoto Tech, Cedartown, Ga. under the trade designation “N4D2A”. In case of transparent substrates, hardcoat coated transparent substrates, as well as display articles comprised of transparent substrates, the haze value can be less than 5%, in another embodiment it can be less than 2% and in yet another embedment it can be less than 1%. Alternatively or in addition thereto, the transmission can be greater than 90%.

Various light transmissive optical films are known, including but not limited to, multilayer optical films, microstructured films such as retroreflective sheeting and brightness enhancing films, (e.g. reflective or absorbing) polarizing films, diffusive films, as well as (e.g. biaxial) retarder films and compensator films such as described in U.S. Pat. No. 7,099,083.

As described in U.S. Pat. No. 6,991,695, multilayer optical films provide desirable transmission and/or reflection properties at least partially by an arrangement of microlayers of differing refractive index. The microlayers have different refractive index characteristics so that some light is reflected at interfaces between adjacent microlayers. The microlayers are sufficiently thin so that light reflected at a plurality of the interfaces undergoes constructive or destructive interference in order to give the film body the desired reflective or transmissive properties. For optical films designed to reflect light at ultraviolet, visible, or near-infrared wavelengths, each microlayer generally has an optical thickness (i.e., a physical thickness multiplied by refractive index) of less than 1 μm. However, thicker layers can also be included, such as skin layers at the outer surfaces of the film, or protective boundary layers disposed within the film that separate packets of microlayers. Multilayer optical film bodies can also comprise one or more thick adhesive layers to bond two or more sheets of multilayer optical film in a laminate.

Further details of suitable multilayer optical films and related constructions can be found in U.S. Pat. No. 5,882,774 (Jonza et al.), and PCT Publications WO 95/17303 (Ouderkirk et al.) and WO 99/39224 (Ouderkirk et al.). Polymeric multilayer optical films and film bodies can comprise additional layers and coatings selected for their optical, mechanical, and/or chemical properties. See U.S. Pat. No. 6,368,699 (Gilbert et al.). The polymeric films and film bodies can also comprise inorganic layers, such as metal or metal oxide coatings or layers.

Hardcoat compositions of the invention can also be used to form hardcoat layers on internal components of optical devices. Such hardcoat layers can be useful to minimize damage to the internal components during assembly of the optical device. The use of such hardcoat layers could reduce the occurrence of defective parts prior to and during the assembly process. Further embodiments and discussion of the use of hardcoat layers in internal components can be found in U.S. patent application Ser. No. 11/267790 entitled “INTERNAL COMPONENTS OF OPTICAL DEVICE COMPRISING HARDCOAT”, filed on Nov. 3, 2005, the disclosure of which is incorporated herein by reference.

The composition of the hardcoat layer 18, prior to application and curing on the substrate 16, is a mixture of a non-fluorinated crosslinking agent and a fluoroacrylate additive. Exemplary methods for forming the hard coating compositions are described below in the experimental section.

In one embodiment of the invention, a hardcoat can be formed from the product of a reaction mixture that includes fluoroacrylate additives according to formula I:

R^{f3}-J-OC(O)NH—K—HNC(O)O—(C_{b}H_{2b})CH₍₃₋ᵥ₎((C_{y}H_{2y})OC(O)C(R⁸)═CH₂)ᵥ (Formula 1)

wherein, R^{f3} is a monovalent perfluoroalkyl group or a polyfluoroalkyl group which can be linear, branched, or cyclic. Exemplary R^{f3} includes, but is not limited to, CₑF₂ₑ₊₁—, wherein e is 1 to 8; CF₃CF₂CF₂CHFCF₂—; CF₃CHFO(CF₂)₃—; (CF₃)₂NCF₂CF₂—; CF₃CF₂CF₂OCF₂CF₂—; CF₃CF₂CF₂OCHCF₂—; n-C₃F₇OCF(CF₃)—; H(CF₂CF₂)₃—; or n-C₃F₇OCF(CF₃)CF₂OCF₂—.

J is a divalent linkage group selected from, but not limited to,

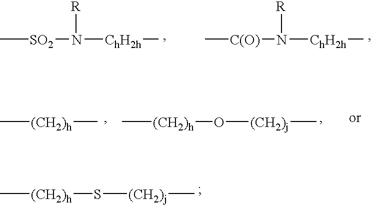

wherein R is H or an alkyl group of 1 to 4 carbon atoms;
h is 2 to 8;
j is 1 to 5;

K is the residue of a diisocyanate with an unbranched symmetric alkylene group, arylene group, or aralkylene group. Exemplary K includes, but is not limited to, —(CH₂)₆—,

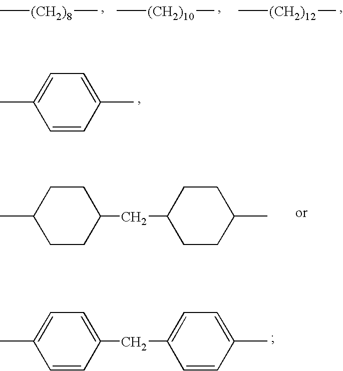

b is 1 to 30;

v is 1 to 3;

y is 0 to 6; and

R⁸ is H, CH₃, or F.

In one embodiment, R^{f3} is a perfluoroalkyl group that includes at least one heteroatom, or a polyfluoroalkyl group that includes at least one heteroatom. Examples of heteroatoms that can be included in either the perfluoroalkyl groups or polyfluroalkyl groups include, but are not limited to, O and N. Specific examples of possible perfluoroalkyl groups, polyfluoroalkyl groups, perfluroalkyl groups including at least one heteroatom, and polyfluoroalkyl groups including at least one heteroatom include, but are not limited to, CₑF₂ₑ₊₁—, wherein e is 1 to 8; CF₃CF₂CF₂CHFCF₂—; CF₃CHFO(CF₂)₃—; (CF₃)₂NCF₂CF₂—; CF₃CF₂CF₂OCF₂CF₂—; CF₃CF₂CF₂OCHCF₂—; H(CF₂CF₂)₃—; or n-C₃F₇OCF(CF₃)CF₂OCF₂—.

In one embodiment, J is

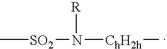

### In another embodiment J is

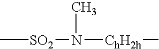

where j is 2 to 4. In yet another embodiment J is

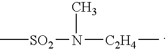

In one embodiment, K is

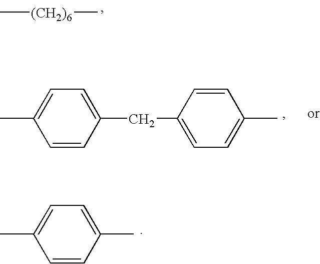

### In another embodiment, K is

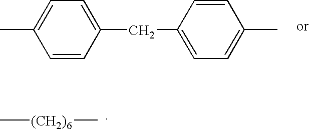

In one embodiment, b is 2 to 12; in another embodiment, b is 2, 4, 6, 10, or 12; in yet another embodiment, b is 2, 4, or 12.

In one embodiment, R⁸ is H.

In one embodiment, v is 1.

Specific fluoro-acrylate-additives useful in the invention may include, but are not limited to, C₄F₉SO₂N(CH₃)C₂H₄O—C(O)NHC₆H₅CH₂C₆H₅NHC(O)—OC₂H₄OC(O)CH═CH₂ (MeFBSE-MDI-HEA), C₄F₉SO₂N(CH₃)C₂H₄O—C(O)NH(CH₂)₆NHC(O)—OC₂H₄OC(O)Me═CH₂ (MeFBSE-HDI-HEMA), C₄F₉SO₂N(CH₃)C₂H₄O—C(O)NH(CH₂)₆NHC(O)—OC₄H₈OC(O)CH═CH₂ (MeFBSE-HDI-BA), C₄F₉SO₂N(CH₃)C₂H₄O—C(O)NH(CH₂)₆NHC(O)—OC₁₂H₂₄OC(O)CH═CH₂ (MeFBSE-HDI-DDA), CF₃CH₂O—C(O)NHC₆H₅CH₂C₆H₅NHC(O)—OC₂H₄OC(O)CH═CH₂ (CF₃CH₂OH-MDI-HEA), C₄F₉CH₂CH₂O—C(O)NHC₆H₅CH₂C₆H₅NHC(O)—OC₂H₄OC(O)CH═CH₂ (C₄F₉CH₂CH₂OH-MDI-HEA), C₆F₁₃CH₂CH₂O—C(O)NHC₆H₅CH₂C₆H₅NHC(O)—OC₂H₄OC(O)CH═CH₂(C₆F₁₃CH₂CH₂OH-MDI-HEA), C₃F₇CHFCF₂CH₂O—C(O)NHC₆H₅CH₂C₆H₅NHC(O)—OC₂H₄OC(O)CH═CH₂ (C₃F₇CHFCF₂CH₂OH-MDI-HEA), CF₃CHFO(CF₂)₃CH₂O—C(O)NHC₆H₅CH₂C₆H₅NHC(O)—OC₂H₄OC(O)CH═CH₂ (CF₃CHFO(CF₂)₃CH₂O-MDI-HEA), C₃F₇OCHFCF₂CH₂O—C(O)NHC₆H₅CH₂C₆H₅NHC(O)—OC₂H₄OC(O)CH═CH₂ (C₃F₇OCHFCF₂CH₂OH-MDI-HEA), C₃F₇OCF(CF₃)CH₂O—C(O)NHC₆H₅CH₂C₆H₅NHC(O)—OC₂H₄OC(O)CH═CH₂ (C₃F₇OCF(CF₃)CH₂OH-MDI-HEA), C₄F₉SO₂NMeC₂H₄O—C(O)NHC₆H₄CH₂C₆H₄NHC(O)—OCH₂C(CH₂OC(O)CH═CH₂)₃ (MeFBSE-MDI-(SR-444C)), and combinations thereof.

These fluoro-acrylate-additives of the invention can be prepared, for example, by first combining a fluorochemical alcohol and an unbranched symmetric diisocyanate in a selected solvent as described in U.S. Pat. No. 7,081,545, and then adding a hydroxy-terminated alkyl(meth)acrylate as described in Pub. No.: US 2005/0143541. The disclosures of both of those publications are incorporated herein by reference.

Generally, the reaction mixture can be agitated. The reaction can generally be carried out at a temperature between room temperature and about 120° C.; in one embodiment, the reaction can be carried out at between 50° C. and 70° C.

Typically the reaction can be carried out in the presence of a catalyst. Useful catalysts include, but are not limited to, bases (for example, tertiary amines, alkoxides, and carboxylates), metal salts and chelates, organometallic compounds, acids and urethanes. In one embodiment, the catalyst is an organotin compound (for example, dibutyltin dilaurate (DBTDL) or a tertiary amine (for example, diazobicyclo[2.2.2]octane (DABCO)), or a combination thereof. In another embodiment, the catalyst is DBTDL.

Fluorochemical alcohols that are useful to form fluoro-acrylate-additives of the invention can be represented by formula 7:

R^{f3}-J-OH (Formula 2)

wherein R^{f3} is a perfluoroalkyl group or a polyfluoroalkyl group,

J is a divalent linkage group selected from, but not limited to,

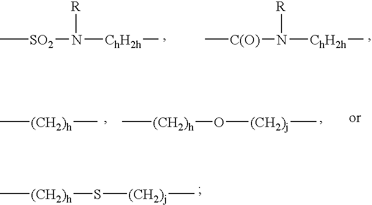

wherein R, h, and j are as defined above.

In one embodiment, R is a perfluoroalkyl group that includes at least one heteroatom, or a polyfluoroalkyl group that includes at least one heteroatom. Examples of heteroatoms that can be included in either the perfluoroalkyl groups or polyfluroalkyl groups include, but are not limited to, O and N. Specific examples of possible perfluoroalkyl groups, polyfluoroalkyl groups, perfluroalky groups including at least one heteroatom, and polyfluoroalkyl groups including at least one heteroatom include, but are not limited to, CₑF₂ₑ₊₁, wherein e is 1 to 8; CF₃CF₂CF₂ CF₂—; CF₃CF₂CF₂CF₂CF₂CF₂—; CF₃CF₂CF₂CHFCF₂—; CF₃CHFO(CF₂)₃—; (CF₃)₂NCF₂CF₂—; CF₃CF₂CF₂OCF₂CF₂—; CF₃CF₂CF₂OCHCF₂—; n-C₃F₇OCF(CF₃)—; H(CF₂CF₂)₃—; or n-C₃F₇OCF(CF₃)CF₂OCF₂—.

Representative examples of suitable alcohols include, but are not limited to, CF₃CH₂OH, (CF₃)₂CHOH, (CF₃)₂CFCH₂OH, C₂F₅SO₂NH(CH₂)₂OH, C₂F₅ SO₂NCH₃(CH₂)₂OH, C₂F₅ SO₂NCH₃(CH₂)₄OH, C₂F₅SO₂NC₂H₅(CH₂)₆OH, C₂F₅(CH₂)₄OH, C₂F₅CONH(CH₂)₄OH, C₃F₇SO₂NCH₃(CH₂)₃OH, C₃F₇SO₂NH(CH₂)₂OH, C₃F₇CH₂OH, C₃F₇CONH(CH₂)₈OH, C₄F₉SO₂NCH₃(CH₂)₂OH, C₄F₉CONH(CH₂)₂OH, C₄F₉SO₂NCH₃(CH₂)₄OH, C₄F₉SO₂NH(CH₂)₇OH, C₄F₉SO₂NC₃H₇(CH₂)₂OH, C₄F₉SO₂NC₄H₉(CH₂)₂OH, C₅F₁₁ SO₂NCH₃(CH₂)₂OH, C₅F₁₁CONH(CH₂)₂OH, C₅F₁₁(CH₂)₄OH, CₑF₂ₑ₊₁(CH₂)₂OH, CₑF₂ₑ₊₁(CH₂)₂O(CH₂)₂OH, CₑF₂ₑ₊₁(CH₂)₂S(CH₂)₂OH, wherein e is 1 to 8; CF₃CF₂CF₂CHFCF₂OH, CF₃CHFO(CF₂)₃ OH, (CF₃)₂NCF₂CF₂OH, CF₃CF₂CF₂OCF₂CF₂OH, CF₃CF₂CF₂OCHCF₂OH, n-C₃F₇OCF(CF₃)OH, H(CF₂CF₂)₃OH, or n-C₃F₇OCF(CF₃)CF₂OCF₂OH.

In one embodiment, e is 2 to 6; in another embodiment, e is 4.

In one embodiment, h is 2 to 4.

In one embodiment, J is

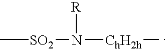

### In another embodiment J is

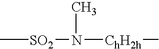

where j is 2 to 4. In another embodiment J is

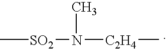

### In yet another embodiment, J is

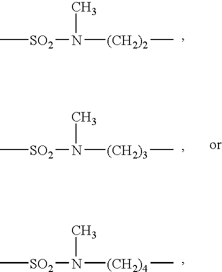

In one embodiment, fluorochemical alcohols that can be utilized to form fluoro-acrylate-additives of the invention include, but are not limited to, C₄F₉SO₂NCH₃(CH₂)₂OH, C₄F₉SO₂NCH₃(CH₂)₄OH, C₆F₁₃(CH₂)₂OH and C₄F₉(CH₂)₂OH. In another embodiment, the fluorochemical alcohol is C₄F₉SO₂NCH₃(CH₂)₂OH.

Representative examples of unbranched symmetric diisocyanates that can be utilized to form fluoro-acrylate-additives of the invention, include, but are not limited to, 4,4′-diphenylmethane diisocyanate (MDI), 1,6-hexamethylene diisocyanate (HDI), 1,4-phenylene diisocyanate (PDI), 1,4-butane diisocyanate (BDI), 1,8-octane diisocyanate (ODI), 1,12-dodecane diisocyanate, and 1,4-xylylene diisocyanate (XDI). In one embodiment, unbranched symmetric diisocyanates include, but are not limited to, MDI, HDI, and PDI. In another embodiment the unbranched symmetric diisocyanate that is utilized is MDI. In its pure form, MDI is commercially available as Isonate™ 125M from Dow Chemical Company (Midland, Mich.), and as Mondur™ from Bayer Polymers (Pittsburgh, Pa.).

Hydroxy-terminated alkyl (meth)acrylates that are useful to form fluoro-acrylate-additives of the invention can have from 2 to 30 carbon atoms. In another embodiment, hydroxyl-terminated alkyl (meth) acrylates that have from 2 to 12 carbon atoms in their alkylene portion are utilized.

In one embodiment, the hydroxy-terminated alkyl (meth)acrylate monomer is a hydroxy-terminated alkyl acrylate. In one embodiment hydroxy-terminated alkyl acrylates include, but are not limited to, hydroxy ethyl acrylate, hydroxy butyl acrylate, hydroxy hexyl acrylate, hydroxy decyl acrylate, hydroxy dodecyl acrylate, HOCH₃—C₆H₁₀—CH₂OC(O)CR═CH₂ and HO(CH₂)₅C(O)OCH₂CH₂OC(O)CH═CH₂, and mixtures thereof. In another embodiment, the hydroxyl-terminated alkyl meth(acrylate) monomer is a triacrylate such as pentaerythritol triacrylate, referred to herein as SR444C, available from Sartomer Company.

One exemplary combination to form fluoro-acrylate-additives of the invention includes the reaction of fluorochemical alcohols represented by the formula CₑF₂ₑ₊₁SO₂NCH₃(CH₂)ₕOH, wherein e is 2 to 5, and h is 2 to 4, are reacted with MDI, the process described in U.S. Pat. No. 7,081,545, entitled “Process For Preparing Fluorochemical Monoisocyanates”, can be used.

The hardcoat may be provided as a single layer disposed on a substrate. In this construction, the wt-% of all fluorinated compounds in the hardcoat composition can range from 1 to 40 wt %. In another embodiment, the wt-% of all fluorinated compounds in the hardcoat composition can range from 1 to 20 wt-%. In a further embodiment, the wt-% of all fluorinated compounds in the hardcoat composition can range from 1 to 10 wt-%.

The hardcoat layer of the invention is formed from the reaction product of a mixture that includes a non-fluorinated crosslinking agent. Such non-fluorinated crosslinking agents can also be referred to as conventional hard coat materials. Examples of such materials, include, but are not limited to hydrocarbon-based materials well known to those of ordinary skill in the optical arts. In one embodiment, the hydrocarbon-based material is an acrylate-based hard coat material. One exemplary hard coat material for use in the invention is based on PETA (pentaerythritol tri/tetra acrylate). One commercially available form of pentaerythritol triacrylate (“PET3A”) is SR444C and one commercially available form of pentaerythritol tetraacrylate (“PET4A”) is SR295, each available from Sartomer Company of Exton, Pa.

However, other non-fluorinated crosslinking agents may also be used in the invention. Useful crosslinking agents include, for example, poly(meth)acryl monomers such as (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as di/trimethylolpropane tetraacrylate, dipentaerythritol pentaacrylate, ethoxylated (4) pentaerythritol tetraacrylate, caprolactone modified dipentaerythritol hexaacrylate; (d) oligomeric (meth)acryl compounds such as, for example, urethane acrylates, polyester acrylates, epoxy acrylates; polyacrylamide analogues of the foregoing; or combinations thereof. Such compounds are widely available from vendors such as, for example, Sartomer Company of Exton, Pa.; UCB Chemicals Corporation of Smyrna, Ga.; and Aldrich Chemical Company of Milwaukee, Wis. Additional useful (meth)acrylate materials include hydantoin moiety-containing poly(meth)acrylates, for example, as described in U.S. Pat. No. 4,262,072 (Wendling et al.).

It can be advantageous to maximize the concentration of the non-fluorinated crosslinking agent particularly since non-fluorinated (meth)acrylate crosslinkers are generally less expensive than fluorinated compounds such as fluoroacrylate additives of the invention. Accordingly, the hardcoat compositions described herein typically comprise at least 20 wt-% non-fluorinated crosslinking agent(s). In one embodiment the hardcoat composition may include at least 50 wt-% non-fluorinated crosslinking agent(s), and may be for example at least 60 wt-%, at least 70 wt-%, at least 80 wt-%, at least 90 wt-% and at least 95 wt-% non-fluorinated crosslinking agent(s).

To facilitate curing, polymerizable compositions according to the invention may further comprise at least one free-radical thermal initiator and/or photoinitiator. Typically, if such an initiator and/or photoinitiator are present, it comprises less than 10 wt-%, in one embodiment less than 5 wt-%, and in another embodiment, less than 2 wt-% of the hardcoat composition. Free-radical curing techniques are well known in the art and include, for example, thermal curing methods as well as radiation curing methods such as electron beam or ultraviolet radiation. Further details concerning free radical thermal and photopolymerization techniques may be found in, for example, U.S. Pat. No. 4,654,233 (Grant et al.); U.S. Pat. No. 4,855,184 (Klun et al.); and U.S. Pat. No. 6,224,949 (Wright et al.).

Useful free-radical thermal initiators include, for example, azo, peroxide, persulfate, and redox initiators, and combinations thereof.

Useful free-radical photoinitiators include, for example, those known as useful in the UV cure of acrylate polymers. Such initiators include, but are not limited to, benzophenone and its derivatives; benzoin, alpha-methylbenzoin, alpha-phenylbenzoin, alpha-allylbenzoin, alpha-benzylbenzoin; benzoin ethers such as benzil dimethyl ketal (commercially available under the trade designation “IRGACURE 651” from Ciba Specialty Chemicals Corporation of Tarrytown, N.Y.), benzoin methyl ether, benzoin ethyl ether, benzoin n-butyl ether; acetophenone and its derivatives such as 2-hydroxy-2-methyl-1-phenyl-1-propanone (commercially available under the trade designation “DAROCUR 1173” from Ciba Specialty Chemicals Corporation) and 1-hydroxycyclohexyl phenyl ketone (commercially available under the trade designation “IRGACURE 184”, also from Ciba Specialty Chemicals Corporation); 2-methyl-1-[4-(methylthio)phenyl]-2-(4-morpholinyl)-1-propanone commercially available under the trade designation “IRGACURE 907”, also from Ciba Specialty Chemicals Corporation); 2-benzyl-2-(dimethylamino)-1-[4-(4-morpholinyl)phenyl]-1-butanone commercially available under the trade designation “IRGACURE 369” from Ciba Specialty Chemicals Corporation); aromatic ketones such as benzophenone and its derivatives and anthraquinone and its derivatives; onium salts such as diazonium salts, iodonium salts, sulfonium salts; titanium complexes such as, for example, that which is commercially available under the trade designation “CGI 784 DC”, also from Ciba Specialty Chemicals Corporation); halomethylnitrobenzenes; and mono- and bis-acylphosphines such as those available from Ciba Specialty Chemicals Corporation under the trade designations “IRGACURE 1700”, “IRGACURE 1800”, “IRGACURE 1850”,“IRGACURE 819” “IRGACURE 2005”, “IRGACURE 2010”, “IRGACURE 2020” and “DAROCUR 4265”. Combinations of two or more photoinitiators may also be used. Further, sensitizers such as 2-isopropyl thioxanthone, commercially available from First Chemical Corporation, Pascagoula, Miss., may be used in conjunction with photoinitiator(s) such as ““IRGACURE 369”.

If desired, the hardcoat composition may further comprise an organic solvent or mixed solvent. The organic solvent used in the free radical crosslinking reaction can be any organic liquid that is inert to the reactants and product, and that will not otherwise adversely affect the reaction. Suitable solvents include alcohols such as methanol, ethanol, isopropanol and carbitol, esters such as ethyl acetate, aromatic solvents such as toluene, chlorinated or fluorinated solvents such as CHCl₃ and C₄F₉OCH₃, ethers such as diethyl ether, THF and t-butyl methyl ether, and ketones, such as acetone and methyl isobutyl ketone. Other solvent systems may also be used. The amount of solvent can generally be about 20 to 90 percent by weight of the total weight of reactants and solvent. It should be noted that in addition to solution polymerization, the crosslinking can be affected by other well-known techniques such as suspension, emulsion, and bulk polymerization techniques.

The composition whose reaction product will be the hardcoat layer can be applied to a substrate layer such as a light transmissible substrate and photocured to form an easy to clean, stain and ink repellent, hardcoat layer.

The polymerizable coating composition for use as the surface layer or underlying hardcoat layer can also include inorganic particles that can add mechanical strength or other desirable properties to the resultant coating. In one embodiment, the inorganic particles can be surface modified particles. Surface modified particles are generally described in U.S. Pat. No. 6,376,590 and U.S. Patent Application Publication No. 2006/0148950, the disclosures of which are incorporated herein by reference.

A variety of inorganic oxide particles can be used in the hardcoat. The particles are typically substantially spherical in shape and relatively uniform in size. The particles can have a substantially monodisperse size distribution or a polymodal distribution obtained by blending two or more substantially monodisperse distributions. The inorganic oxide particles are typically non-aggregated (substantially discrete), as aggregation can result in precipitation of the inorganic oxide particles or gelation of the hardcoat. The inorganic oxide particles are typically colloidal in size, having an average particle diameter of 0.001 to 0.2 micrometers, less than 0.05 micrometers, and less than 0.03 micrometers. These size ranges can facilitate dispersion of the inorganic oxide particles into the binder resin and provide ceramers with desirable surface properties and optical clarity. The average particle size of the inorganic oxide particles can be measured using transmission electron microscopy to count the number of inorganic oxide particles of a given diameter.

The inorganic oxide particles can include a single oxide such as silica, or can comprise a combination of oxides, such as silica and aluminum oxide, or a core of an oxide of one type (or a core of a material other than a metal oxide) on which is deposited an oxide of another type. Silica is a common inorganic particle.

The inorganic oxide particles are often provided in the form of a sol containing a colloidal dispersion of inorganic oxide particles in liquid media. The sol can be prepared using a variety of techniques and in a variety of forms including hydrosols (where water serves as the liquid medium), organosols (where organic liquids so serve), and mixed sols (where the liquid medium contains both water and an organic liquid), e.g., as described in U.S. Pat. No. 5,648,407 (Goetz et al.); U.S. Pat. No. 5,677,050 (Bilkadi et al.) and U.S. Pat. No. 6,299,799 (Craig et al.), the disclosure of which is incorporated by reference herein. Aqueous sols (e.g. of amorphous silica) can be employed. Sols generally contain at least 2 wt-%, at least 10 wt-%, at least 15 wt-%, at least 25 wt-%, and often at least 35 wt-% colloidal inorganic oxide particles based on the total weight of the sol. The amount of colloidal inorganic oxide particle is typically no more than 50 wt-% (e.g. 45 wt-%). The surface of the inorganic particles can be “acrylate functionalized” as described in U.S. Pat. No. 5,677,050. The sols can also be matched to the pH of the binder, and can contain counterions or water-soluble compounds (e.g., sodium aluminate), all as described in Kang et al. '798.

One example of such particles is colloidal silica reacted with a methacryl silane coupling agent such as A-174 (available from Natrochem, Inc.), other dispersant aids such as N,N dimethylacrylamide and various other additives (stabilizers, initiators, etc.).

A particulate matting agent can also be incorporated into the polymerizable composition in order to impart anti-glare properties to the surface layer. The particulate matting agent can also prevent the reflectance decrease and uneven coloration caused by interference with an associated hard coat layer. The particulate matting agent is generally transparent, exhibiting transmission values of greater than about 90%. Alternatively, or in addition thereto, the haze value can be less than 5%, and in one embodiment is less than 2%, and in another embodiment is less than 1%.

Exemplary systems incorporating matting agents into a hard coating layer, but having a different hard coating composition, are described, for example, in U.S. Pat. No. 7,101,618, and incorporated herein by reference. Further, exemplary matte films are commercially available from U.S.A. Kimoto Tech of Cedartown, Ga., under the trade designation “N4D2A.”

The amount of particulate matting agent added can be between 0.5 and 10 wt-%, depending upon the thickness of the hardcoat layer. In one embodiment, it is around 2 wt-%. A hardcoat layer that is to also function as an anti-glare layer can have a thickness of 0.5 to 10 microns, in another embodiment 0.8 to 7 microns, which is generally in the same thickness range of gloss hard coatings.

The average particle diameter of the particulate matting agent has a predefined minimum and maximum that is partially dependent upon the thickness of the layer. However, generally speaking, average particle diameters below 1.0 microns do not provide the degree of anti-glare sufficient to warrant inclusion, while average particle diameters exceeding 10.0 microns deteriorate the sharpness of the transmission image. The average particle size is thus generally between 1.0 and 10.0 microns, and in another embodiment is between 1.7 and 3.5 microns, in terms of the number-averaged value measured by the Coulter method.

As the particulate matting agent, inorganic particles or resin particles are used including, for example, amorphous silica particles, TiO₂ particles, Al₂O₃ particles, cross-linked acrylic polymer particles such as those made of cross-linked poly(methyl methacrylate), cross-linked polystyrene particles, melamine resin particles, benzoguanamine resin particles, and cross-linked polysiloxane particles. By taking into account the dispersion stability and sedimentation stability of the particles in the coating mixture for the anti-glare layer and/or the hard coat layer during the manufacturing process, resin particles can be utilized, and in one embodiment cross-linked polystyrene particles can be used since resin particles have a high affinity for the binder material and a small specific gravity.

As for the shape of the particulate matting agent, spherical and amorphous particles can be used. However, to obtain a consistent anti-glare property, spherical particles are desirable. Two or more kinds of particulate materials may also be used in combination.

Other types of inorganic particles can also optionally be incorporated into the hardcoat compositions of this invention. In one embodiment conducting metal oxide nanoparticles such as antimony tin oxide, fluorinated tin oxide, vanadium oxide, zinc oxide, antimony zinc oxide, and indium tin oxide can be included in the composition. The metal oxides can also be surface treated with materials such as 3-methacryloxypropyltrimethoxysilane. These particles can provide constructions with antistatic properties and other desirable properties. This can be desirable to prevent static charging and resulting contamination by adhesion of dust and other unwanted debris during handling and cleaning of the film. In one such embodiment, such metal oxide particles are incorporated into the top (thin) layer of two-layer embodiments of this invention, in which the fluoroacrylate containing hardcoat is applied to a hydrocarbon-based hardcoat. At the levels at which such particles may be needed in the coating in order to confer adequate antistatic properties (typically 25 wt % and greater), these deeply colored particles can impart undesired color to the construction. However, in the thin top layer of a two-layer fluorinated hardcoat construction, their effect on the optical and transmission properties of the film can be minimized. Examples of conducting metal oxide nanoparticles useful in this embodiment include antimony double oxide available from Nissan Chemical under the trade designations Celnax CXZ-210IP and CXZ-210IP-F2. When these particles are included at appropriate levels in the coatings of this invention, the resulting fluorinated hardcoats can exhibit static charge decay times less than about 0.5 sec. In this test, the sample is placed between two electrical contacts and charged to ±5 kV. The sample is then grounded, and the time necessary for the charge to decay to 10% of its initial value is measured and recorded as the static charge decay time. In contrast, film constructions containing no conducting nanoparticles exhibit static charge decay times >30 sec.

The polymerizable coating composition for use as the surface layer or underlying hardcoat layer may also include other materials as deired. For example, it may be desired to include materials to enhance the coating performance or improve performance to allow the coatings to function better in different application. In one embodiment, one or more hindered amine light stabilizer(s) (HALS) and /or one or more phosphonate stabilizer compound(s) may be added in the polymerizable coating composition, as described in U.S. Pat. No. 6,613,819, “Light Stable Articles”.

Hardcoat compositions can be applied to a substrate 16 to form a hardcoat layer 18 using a variety of techniques, including dip coating, forward and reverse roll coating, wire wound rod coating, and die coating. Die coaters include knife coaters, slot coaters, slide coaters, fluid bearing coaters, slide curtain coaters, drop die curtain coaters, and extrusion coaters among others. Many types of die coaters are described in the literature such as by Edward Cohen and Edgar Gutoff, Modern Coating and Drying Technology, VCH Publishers, NY 1992, ISBN 3-527-28246-7 and Gutoff and Cohen, Coating and Drying Defects: Troubleshooting Operating Problems, Wiley Interscience, NY ISBN 0-471-59810-0.

A die coater generally refers to an apparatus that utilizes a first die block and a second die block to form a manifold cavity and a die slot. The coating fluid, under pressure, flows through the manifold cavity and out the coating slot to form a ribbon of coating material. Coatings can be applied as a single layer or as two or more superimposed layers. Although it is usually convenient for the substrate to be in the form of a continuous web, the substrate may also be a succession of discrete sheets.

One embodiment of the invention includes a method of forming a hardcoat layer on a substrate that includes the steps of providing a hardcoat composition that includes i) at least one non-fluorinated crosslinking agent, ii) at least one compound having the formula:

R^{f3}-J-OC(O)NH—K—HNC(O)O—(C_{b}H_{2b})CH₍₃₋ᵥ₎((C_{y}H_{2y})OC(O)C(R⁸)═CH₂)ᵥ (Formula 1)

wherein, R^{f3} is a perfluoroalkyl group or a polyfluoroalkyl group including, but not limited to, CₑF₂ₑ₊₁, wherein e is 1 to 8; CF₃CF₂CF₂CHFCF₂—; CF₃CHFO(CF₂)₃—; (CF₃)₂NCF₂CF₂—; CF₃CF₂CF₂OCF₂CF₂—; CF₃CF₂CF₂OCHCF₂—; H(CF₂CF₂)₃—; or n-C₃F₇OCF(CF₃)CF₂OCF₂—.

J is a divalent linkage group selected from, but is not limited to,

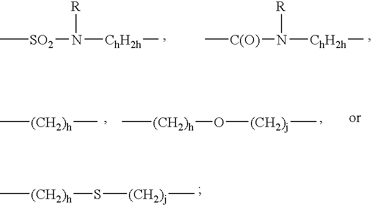

wherein R is H or an alkyl group of 1 to 4 carbon atoms;
h is 2 to 8;
j is 1 to 5;

K is the residue of a diisocyanate with an unbranched symmetric alkylene group, arylene group, or aralkylene group; examples of K include, but are not limited to, —(CH₂)₆—,

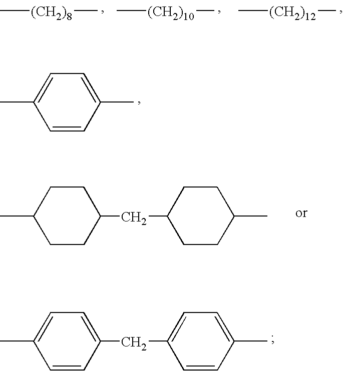

b is 1 to 30;

v is 1 to 3;

y is 0 to 6; and

R⁸ is H, CH₃, or F.

iii) at least one initiator; at least one solvent;
applying the hardcoat composition to a substrate; removing at least a portion of the solvent; and curing the hardcoat composition to form a hardcoat layer on the substrate.

A variety of substrates can be utilized in the articles of the invention. Suitable substrate materials include, but not limited to, fibrous substrates, such as woven, non-woven and knit fabrics, textiles, carpets, leather, and paper, and hard substrates, such as vinyl, wood, glass, ceramic, masonry, concrete, natural stone, man-made stone, grout, metal sheets and foils, wood, paint, plastics, and films of thermoplastic resins, such as polyesters, polyamides (nylon), polyolefins, polycarbonates and polyvinylchloride, and the like. One kind of the substrates with special interesting is optical clear.

The adhesion between the substrate and the hardcoat layer can be improved when the substrate is chosen based in part on the presence of reactive groups that are capable of forming a covalent or hydrogen bond with reactive groups in the coating composition. Examples of such reactive group include, but are not limited to, chloride, bromide, iodide, alkene (C═C), alkyne, —OH, —CO₂, CONH groups and the like. The substrate can be treated to further improve the adhesion between the substrate and the hardcoat layer, e.g., by incorporating reactive groups into the substrate surface though chemical treatment, etc. If desired, an optional tie layer or primer can be applied to the substrate and/or hardcoat layer to increase the interlayer adhesion.

To illustrate the effectiveness of the hard coat formulations according to embodiments of the invention described above, sample hard coats having the given compositions were formulated and applied to PET substrates and compared to hard coat formulations having less than all the desired components. The coatings were visually inspected and tested for ink repellency, durability and surface roughness. The experimental procedures and tabulated results are described below.

### Experimental

### A. Materials

Unless otherwise noted, as used in the examples, “HFPO—” refers to the end group F(CF(CF₃)CF₂O)ₐCF(CF₃)— of the methyl ester F(CF(CF₃)CF₂O)ₐCF(CF₃)C(O)OCH₃ wherein a averages about 6.22, with an average molecular weight of 1,211 g/mol, can be prepared according to the method reported in U.S. Pat. No. 3,250,808 (Moore et al.), the disclosure of which is incorporated herein by reference, with purification by fractional distillation.

HFPO—OH or HFPO—C(O)NHCH₂CH₂OH was prepared according to paragraph [0058] of US 20060148350 from HFPO—C(O)OCH₃ and NH₂CH₂CH₂OH. The average molecule weight is about 1344.

SR444C, Pentaerythritol triacrylate (“PET3A”), was obtained from Sartomer Company of Exton, Pa.

TMPTA, Trimethylolpropane triacrylate, under the trade designation “SR351”, was obtained from Sartomer Company of Exton, Pa.

MeFBSEA, C₄F₉SO₂N(CH₃)CH₂CH₂OC(O)CH═CH₂, is made by the procedure of Examples 2A and 2B of WO 01/30873 to Savu et al., available from 3M Co.;

The UV photoinitiator, DAROCUR 1173, obtained from Ciba Specialty Chemicals Corporation.

Methyl perfluorobutyl ether (HFE 7100) was obtained from 3M Company, St. Paul, Minn.

DBTDL, Dibutyltin dilaurate, was obtained from Sigma Aldrich of Milwaukee, Wis.

Unless otherwise noted, “MW” refers to molecular weight and “EW” refers to equivalent weight. Further, “° C.” may be used interchangeably with “degrees Celsius” and “mol” refers to moles of a particular material and “eq” refers to equivalents of a particular material. Further, “Me” constitutes a methyl group and may be used interchangeably with “CH₃.”

“906” or “906 Hardcoat formulation”, refers to a composition commercially available from 3M, St. Paul, Minn. that includes: 18.4 wt % 20 nm silica (Nalco 2327) surface modified with methacryloyloxypropyltrimethoxysilane (acrylate silane), 25.5 wt % Pentaerthritol tri/tetra acrylate (PETA), 4.0 wt % N,N-dimethylacrylamide (DMA), 1.2 wt % Irgacure 184, 1.0 wt % Tinuvin 292, 46.9 wt % solvent isopropanol, and 3.0 wt % water.

“ZrO₂ High reflex Index Hardcoat formulation” refers to a composition that includes: 50 wt % Buhler ZrO₂ surface modified with 1.1 mmol silane/g of ZrO₂, 9.0% 3/1 acrylate silane/A-1230, 37.4% dipentaerythritol pentaacrylate, and 3.6% 819 photoinitiator. A coating solution of ZrO₂ High reflex Index Hardcoat formulation includes 7% solid ZrO₂ High reflex Index Hardcoat formulation in 10/1 acetone/dowanol

P-36 is acrylated benzophenone, available from UCB as Ebercyl P-36;

KF-2001 is a copolymer of (mercaptopropyl)methylsiloxane and dimethylsiloxane, —[SiMe₂O]x-[SiMe(C₃H₆SH)O]y-, MW 8,000/4-SH, available from Shin-Etsu, Japan;

PEGDA is CH₂═CHCO₂(CH₂CH₂O)ₙC(O)CH═CH₂ with average MW ˜700, available from Aldrich;

SR399, Dipentaerythritol Pentaacrylate, available from Sartomer;

ODA, octodecyl acrylate, C₁₈H₃₇OC(O)CH═CH₂, available from Aldrich;

HEA, CH₂═CHCO₂CH₂CH₂OH, available from Aldrich;

C4-Silicone is a mixture of Q2-7785 and Q2-7560 in 90/10 ratio by weight, both are available from Dow Corning Chemical;

A-174, CH₂═C(CH₃)CO₂CH₂CH₂Si(OMe)₃, available from Natrochem, Inc. Solvents: methyl ethyl ketone (MEK), acetone, ethyl eacetate (EtOAc), methyl isobutyl ketone (MIBK) and isopropyl alcohol (IAP) were obtained from Aldrich;

### B. Preparation of Additives

### Preparation of FA-1, MeFBSE-MDI-HEA (Also Referred to as C4MH)

C₄F₉SO₂N(CH₃)C₂H₄O—C(O)NHC₆H₅CH₂C₆H₅NHC(O)—OC₂H₄OC(O)CH═CH₂ (MeFBSE-MDI-HEA) was prepared according to the procedure described in US Patent Application Publication No. 2005/0143541, paragraph 0104.

### Preparation of FC-3, C₄F₉SO₂N(CH₃)C₂H₄O—C(O)NH(CH₂)₆NHC(O)—OC₂H₄OC(O)Me═CH₂ (MeFBSE-HDI-HEMA)

FC-3, C₄F₉SO₂N(CH₃)C₂H₄O—C(O)NH(CH₂)₆NHC(O)—OC₂H₄OC(O)Me═CH₂ (MeFBSE-HDI-HEMA) was prepared according to the procedure described in US Patent Application Publication No. 2005/0143541, paragraph 0104 by substituting HDI for MDI and HEMA for HEA.

### Preparation of FC-4, C₄F₉SO₂N(CH₃)C₂H₄O—C(O)NH(CH₂)₆NHC(O)—OC₄H₈OC(O)CH═CH₂ (MeFBSE-HDI-BA)

FC-4, C₄F₉SO₂N(CH₃)C₂H₄O—C(O)NH(CH₂)₆NHC(O)—OC₄H₈OC(O)CH═CH₂ (MeFBSE-HDI-BA) was prepared according to the procedure described in US Patent Application Publication No. 2005/0143541, paragraph 0104 by substituting HDI for MDI and BA for HEA.

### Preparation of FC-5, C₄F₉SO₂N(CH₃)C₂H₄O—C(O)NH(CH₂)₆NHC(O)—OC₁₂H₂₄OC(O)CH═CH₂ (MeFBSE-HDI-DDA)

FC-5, C₄F₉SO₂N(CH₃)C₂H₄O—C(O)NH(CH₂)₆NHC(O)—OC₁₂H₂₄OC(O)CH═CH₂ (MeFBSE-HDI-DDA) was prepared according to the procedure described in US Patent Application Publication No. 2005/0143541, paragraph 0104 by substituting HDI for MDI and DDA for HEA.

### Preparation of FC-6, CF₃CH₂O—C(O)NHC₆H₅CH₂C₆H₅NHC(O)—OC₂H₄OC(O)CH═CH₂ (CF₃CH₂OH-MDI-HEA)

FC-6, CF₃CH₂O—C(O)NHC₆H₅CH₂C₆H₅NHC(O)—OC₂H₄OC(O)CH═CH₂ (CF₃CH₂OH-MDI-HEA) was prepared according to the procedure described in US Patent Application Publication No. 2005/0143541, paragraph 0110.

### Preparation of FC-2, C₄F₉SO₂NMeC₂H₄O—C(O)NHC₆H₄CH₂C₆H₄NHC(O)—OCH₂C(CH₂OC(O)CH═CH₂)₃ (MeFBSE-MDI-(SR-444C))

C₄F₉SO₂NMeC₂H₄O—C(O)NHC₆H₄CH₂C₆H₄—NCO (MeFBSE-MDI) was prepared according to the procedure described in US Patent Application Publication No. 2005/0143541, paragraph 0103. C₄F₉SO₂NMeC₂H₄O—C(O)NHC₆H₄CH₂C₆H₄NHC(O)—OCH₂C(CH₂OC(O)CH═CH₂)₃ (MeFBSE-MDI-(SR-444C)) was prepared as follows. A 240 ml bottle was charged with 24.65 g MeFBSE-MDI (MW=723, 34.1 mmol), 16.85 grams SR-444C (EW˜494.3, 34.1 mmol), 114.5 g EtOAc and 3 drops of DBTDL catalyst. After sealing the bottle, the solution was put in a heated oil bath and reacted at 70 degrees Celsius for four hours with a magnetic stir bar. FTIR analysis indicated the disappearance of —NCO, and the formation of urethane, however, the obtained solution was not completely clear at room temperature. DMF (10 g) was added to the solution to give a clear solution for evaluation.

Control-1, Control-11 and Control-22 referred to in the Tables below was made according to Exp. No#1, of US Pub No. 20060142519.

Control-2, Control-12 and Control-21 referred to in the Tables below was made according to Exp. No#27, of US Pub No. 20050143541.

Control-3 referred to in the Tables below was made according to Exp. No#28, of US Pub No. 20060142519.

### Preparation of Control-6, Control-9 and Control-10 HFPO—OH/N100/SR-444C (15/100/85, HFPO)

A 500 ml round bottom flask equipped with magnetic stir bar was charged with 25.0 g (100 mole percent) (0.131 eq, 191 EW) Des N100, 55.5 g (85 mole percent) (0.087 eq, 494.3 EW) of Sartomer SR444C, 11.5 mg (15 mole percent) of MEHQ, and 126.77 g methyl ethyl ketone (MEK). The reaction was swirled to dissolve all the reactants, the flask was placed in an oil bath at 60 degrees Celsius, and fitted with a condenser under dry air. Two drops of dibutyltin dilaurate was added to the reaction. After 1 hour, 58.64 g (0.0436 eq, 1344 EW) F(CF(CF₃)CF₂O)_{6.85}CF(CF₃)C(O)NHCH₂CH₂OH (HFPO—OH) was added to the reaction via addition funnel over about 75 minutes. The reaction was monitored by FTIR and showed a small isocyanate absorption at 2273 cm⁻¹ after about 5 hours of reaction. The isocyanate absorption signal disappeared after reaction for 7.5 hours. The material was used as a 50% solids solution in MEK.

### C. Test Methods

### Method for Determining Contact Angle:

The coatings were rinsed for 1 minute by hand agitation in IPA before being subjected to measurement of water and hexadecane contact angles. Measurements were made using as-received reagent-grade hexadecane (Aldrich) and deionized water filtered through a filtration system obtained from Millipore Corporation (Billerica, Mass.), on a video contact angle analyzer available as product number VCA-2500XE from AST Products (Billerica, Mass.). Reported values are the averages of measurements on at least three drops measured on the right and the left sides of the drops. Drop volumes were 5 μL for static measurements and 1-3 μL for advancing and receding. For hexadecane, only advancing and receding contact angles are reported because static and advancing values were found to be nearly equal.

### Method for Determining Marker Repellency:

For this test one of the Sharpie Permanent Marker, Vis-à-vis Permanent Overhead Project Pen or King Size Permanent Marker (all commercially available from Sanford, USA) were used as the marker. First, the tip of the selected marker was cut with a razor blade to provide a wide flat marking tip. Then, using the marker and an edge of a straight ruler as a guide, a straight line was drawn over the sample coatings applied over a PET substrate at an approximate speed of 15 cm per second. The appearance of the straigt line drawn on the coatings was viewed and a number was assigned to reflect the degree of repellency of the sample coating towards markers. An assigned number of 1 indicates excellent repellency while an assigned number of 5 indicates poor repellency. Depending on the type of marker used, the results are reported as Sharpie test, Vis-à-vis test or King marker test.

### Method for Determining Solvent Resistance:

For this test, a drop (about 1.25 cm in diameter) of methyl ethyl ketone (MEK) or other organic solvent was placed on a sample coating applied over a PET substrate, and was allowed to dry at room temperature. Afterwards, the sample coating was visually observed for appearance and rated either as Haze (H), indicating poor solvent repellency or poor solvent resistance, or Clear (C), indicating good solvent repellency or solvent resistance. Furthermore, using the above “method for marker test”, the sharpie test was repeated on the spot where a drop of MEK or organic solvent repellency test was conducted, and a marker repellency number ranging from 1 to 5 was assigned.

### Steel Wool Testing:

The abrasion resistance of the cured films was tested cross-web to the coating direction by use of a mechanical device capable of oscillating cheesecloth or steel wool fastened to a stylus (by means of a rubber gasket) across the film's surface. The stylus oscillated over a 10 cm wide sweep width at a rate of 3.5 wipes/second wherein a “wipe” is defined as a single travel of 10 cm. The stylus had a flat, cylindrical geometry with a diameter of 1.25 inch (3.2 cm). The device was equipped with a platform on which weights were placed to increase the force exerted by the stylus normal to the film's surface. The cheesecloth was obtained from Summers Optical, EMS Packaging, a subdivision of EMS Acquisition Corp., Hatsfield, Pa. under the trade designation “Mil Spec CCC-c-440 Product #S12905”. The cheesecloth was folded into 12 layers. The steel wool was obtained from Rhodes-American, a division of Homax Products, Bellingham, Wash. under the trade designation “#0000-Super-Fine” and was used as received. A single sample was tested for each example, with the weight in grams applied to the stylus and the number of wipes employed during testing reported.

### D. Preparation of Hardcoat Compositions and the Resulting Hardcoat Layers

Coating formulations were generally prepared by addition of C4MH (30% solution in ethyl acetate) or other additives into a UV-curable hydrocarbon (multi)acrylate and nanoparticle containing hydrocarbon crosslinkers in different ratios with about 2% DAROCUR 1173 photoinitiator, except the formulations with 906 hardcaot and ZrO₂ high refelex index hardcoat where photoinitiators were mixed in. Coating formulations described in Tables below were diluted with a blended solvent of 1:1 isopropanol:ethyl acetate and coated at a dry thickness of about 4 microns using a number 9 wire wound rod onto 5-mil Melinex 618 film. The coatings were dried in an 100 degree Celsius oven for 1 to 2 minutes and then placed on a conveyer belt coupled to a ultraviolet (“UV”) light curing device and UV cured under nitrogen using a Fusion 500 watt H bulb at 20 ft/min. The values reported in the Tables refer to the percent solids of each component of the dried coating. The coatings were then visually inspected for surface smoothness (dewetting). The coatings were also tested for durability of ink repellency.

Fluoropolymer coatings for Control-1, Control-2, Control-3, Control-11, Control-12, Control-21 and Control-22 were made by the polymerization of C4MH with the other co-monomer according to the procedures described above. The coating solution was diluted to 5%, and coated on 5-mil Melinex 618 film with a number 9 wire wound rod. The coated film was dried in a 110 degree Celsius oven for 5 minutes, and evaluated after cooling to room temperature.

The coating quality and marker repellency performance results from different formulations are reported in Tables I and II. Contact angles from representative formulations are presented in Table III.

TABLE I
Marker Repellent Performance from Hard Coating with C4MH Additive on
PET Film

| Exp. | Coating Formulation | Coating | | | |
|---|---|---|---|---|---|
| No.# | (Ratio by weight), solid % | Quality | Sharpie | Vis-à-vis | King Size |
| 1 | C4MH/TMPTA (1.5/98.5), 30% | Good | 3 | 3 | 4 |
| 2 | C4MH/TMPTA (2/98), 30% | Good | 1 | 1 | 1 |
| 3 | C4MH/TMPTA (5/95), 30% | Good | 1 | 1 | 1 |
| 4 | C4MH/TMPTA (10/90), 30% | Good | 1 | 1 | 1 |
| 5 | C4MH/TMPTA/P-36 (5/95/0.5), | Good | 1 | 1 | 1 |
| | 30% | | | | |
| 6 | C4MH/TMPTA/P-36 (5/95/1.5), | Good | 1 | 1 | 1 |
| | 30% | | | | |
| 7 | C4MH/C4-Silicone/TMPTA | Good | 1 | 1 | 1 |
| | (5/5/90), 30% | | | | |
| 8 | C4MH/SR444C (2/98), 20% | Good | 1 | 1 | 1 |
| 9 | C4MH/SR-399 (2/98), 20% | Good | 1 | 1 | 1 |
| 10 | C4MH/PEGDA (2/98), 25% | Good | 5 | 5 | 5 |
| 11 | C4MH/PEGDA (10/90), 25% | Good | 3 | 3 | 3 |
| 12 | C4MH/PEGDA (20/80), 25% | OK | 1 | 1 | 1 |
| 13 | C4MH/PEGDA (40/60), 25% | Haze | 4 | 5 | 5 |
| 14 | C4MH/PEGDA/906 (20/20/60) | Good | 1 | 1 | 2 |
| Control-1 | C4MH/PEGDA polymer (90/10), | Good | 5 | 5 | 5 |
| | 5% | | | | |
| Control-2 | C4MH/ODA Polymer (70/30), 5% | Good | 5 | 5 | 5 |
| Control-3 | C4MH/TMPTA polymer (90/10), | Good | 5 | 5 | 5 |
| | 5% | | | | |
| Control-4 | MeFBSLA/TMPTA (5/95), 30% | Good | 5 | 5 | 5 |
| Control-5 | MeFBSLA/TMPTA (10/90), 30% | Good | 3 | 3 | 3 |
| Control-6 | HFPO/TMPTA (1/99), 30% | Good | 1 | 1 | 1 |

TABLE II
Nano-hard Coating Marker Repellent with C4MH Additive on PET Film

| | Coating Formulation | Coating | | | |
|---|---|---|---|---|---|
| Exp. No.# | (Ratio by weight), solid % | Quality | Sharpie | Vis-à-vis | King Size |
| 15 | C4MH/906 (1/99), 30% | Good | 5 | 5 | 5 |
| 16 | C4MH/906 (1.5/98.5), 30% | Good | 5 | 5 | 5 |
| 17 | C4MH/906 (2/98), 30% | Good | 1 | 1 | 1 |
| 18 | C4MH/906 (5/95), 30% | Good | 1 | 1 | 1 |
| 19 | C4MH/906 (10/90), 30% | Good | 1 | 1 | 1 |
| 20 | C4MH/906/P-36 (5/95/0.5), 30% | Good | 1 | 1 | 1 |
| 21 | C4MH/906/P-36 (5/95/1.5), 30% | Good | 1 | 1 | 1 |
| 23 | C4MH/906/HEA (5/85/10), 30% | Good | 1 | 1 | 2 |
| 24 | C4MH/906/KF-2001 (5/85/10) | Good | 1 | 1 | 3 |
| 24 | C4MH/906/KF-2001 (5/80/15) | Good | 1 | 1 | 3 |
| 25 | C4MH/906/KF-2001 (5/70/25) | Good | 1 | 1 | 4 |
| 26 | C4MH/ZrO₂ (5/95) | Good | 1 | N/A | N/A |
| 27 | C4MH/ZrO₂ (2/98) | Good | 1 | N/A | N/A |
| 28 | C4MH/ZrO₂ (1/99) | Good | 1 | N/A | N/A |
| 29 | FC-2/906 (10/90), 30% | Good | 1 | 1 | 3 |
| 30 | FC-3/906 (5/95), 15% | Good | 1~2 | 2~3 | 4 |
| 31 | FC-4/906 (5/95), 20% | Good | 1 | 1 | 2 |
| 32 | FC-5/906 (5/95), 20% | Good | 1 | 1 | 3 |
| 33 | FC-6/906 (5/95), 20% | Good | 5 | 5 | 5 |
| Control-7 | MeFBSLA/906 (5/95) | Good | 5 | 5 | 5 |
| Control-8 | MeFBSLA/906 (10/90) | Good | 3 | 3 | 3 |
| Control-9 | HFPO/906 (1/99) | Good | 1 | 1 | 1 |

TABLE III
Contact Angle Data from Coatings on PET Film

| | Coating Formulation | Ad- | Rec | Ad- | Rec |
|---|---|---|---|---|---|
| Exp. No.# | (Ratio by weight), solid % | H₂O | H₂O | Oil | Oil |
| 34 | C4MH/906 (1.5/98.5), 30% | 78 | 78 | 20 | 6 |
| 35 | C4MH/906 (2/98), 30% | 111 | 93 | 72 | 63 |
| 36 | C4MH/906 (5/95), 30% | 116 | 105 | 70 | 64 |
| 37 | C4MH/906 (10/90), 30% | 117 | 107 | 72 | 65 |
| 38 | C4MH/906/P-36 (5/95/0.5), 30% | 118 | 106 | 70 | 64 |
| 39 | C4MH/906/P-36 (5/95/1.5), 30% | 118 | 105 | 71 | 65 |
| 40 | C4MH/TMPTA (1.5/98.5), 30% | 86 | 58 | 42 | 17 |
| 41 | C4MH/TMPTA (2/98), 30% | 120 | 107 | 70 | 64 |
| 42 | C4MH/TMPTA (5/95), 30% | 121 | 110 | 73 | 63 |
| 43 | C4MH/TMPTA (10/90), 30% | 123 | 111 | 73 | 64 |
| 44 | C4MH/TMPTA/P-36 (5/95/0.5), | 121 | 107 | 71 | 65 |
| | 30% | | | | |
| 45 | C4MH/TMPTA/P-36 (5/95/1.5), | 123 | 110 | 72 | 64 |
| | 30% | | | | |
| 46 | C4MH/C4-Silicone/TMPTA | 110 | 91 | 41 | 27 |
| | (5/5/90) | | | | |
| 47 | C4MH/PEGDA (10/90) | 111 | 57 | 66 | 57 |
| 48 | C4MH/PEGDA (20/80) | 116 | 89 | 76 | 67 |
| 49 | C4MH/906/HEA (5/85/10) | 120 | 83 | 72 | 63 |
| 50 | C4MH/906/KF-2001 (5/85/10) | 121 | 79 | 70 | 52 |
| 51 | C4MH/PEGDA/906 (20/20/60) | 116 | 90 | 75 | 64 |
| Control-10 | HFPO/906 (1/99) | 107 | 84 | 66 | 54 |
| Control-11 | C4MH/PEGDA polymer (90/10) | 114 | 97 | 69 | 62 |
| Control-12 | C4MH/ODA polymer (70/30) | 128 | 92 | 81 | 66 |

From Table I, II and III, good to excellent smooth coatings were obtained when the short C₄F₉-tailed acrylate additive was added in 20% or less by weight in the formulations, indicating the good compatibility of fluorinated acrylate additives with non-fluorinated crosslinker(s).

From Table III, it can be seen that the contact angle data from these spaced, short C₄F₉-tailed acrylate additives coincide well with the marker performance in Table I and II, indicating that the contact angles play an important role in marker resistant performance. The contact angle data and marker performance data also coincide well in the HFPO-based formulation (Control-10).

The performance of the hardcoat on different substrates was also examined. Representative marker repellency and contact angles were measured and are shown in Table IV and Table V.

TABLE IV
Marker Repellency of Hardcoat Compositions on Different Substrates:

| | Coating Formulation | | | |
|---|---|---|---|---|
| | (Ratio by weight), | | | King |
| Exp. No.# | solid % | Substrate | Sharpie | Size |
| 52 | C4MH/906 (5/95), 30% | Vinyl | 1 | 1 |
| 53 | C4MH/TMPTA (5/95), | Vinyl | 1 | 1 |
| | 30% | | | |
| 54 | C4MH/TMPTA (10/90), | Vinyl | 1 | 1 |
| | 30% | | | |
| Control-13 | No coating | Vinyl | 5 | 5 |
| 55 | C4MH/906 (5/95), 30% | Stainless Steel | 1 | 1 |
| Control-14 | No coating | Stainless Steel | 5 | 5 |
| 56 | C4MH/906/A-174 | Ceramic Tile | 1 | 1 |
| | (5/93/2), 30% | | | |
| Control-15 | No coating | Ceramic Tile | 5 | 5 |
| 57 | C4MH/TMPTA (10/90), | Aluminum metal | 1 | 1 |
| | 30% | | | |
| 58 | C4MH/TMPTA (5/95), | Aluminum metal | 1 | 1 |
| | 30% | | | |
| 59 | C4MH/906 (5/95), 30% | Aluminum metal | 1 | 1 |
| 60 | C4MH/906 (10/90), 30% | Aluminum metal | 1 | 1 |
| Control-16 | No coating | Aluminum metal | 5 | 5 |
| 61 | C4MH/TMPTA (5/95), | PMMA | 1 | 1 |
| | 30% | | | |
| 62 | C4MH/TMPTA (10/90), | PMMA | 1 | 1 |
| | 30% | | | |
| 63 | C4MH/906 (5/95), 30% | PMMA | 1 | 1 |
| 64 | C4MH/906 (10/90), 30% | PMMA | 1 | 1 |
| Control-17 | No coating | PMMA | 5 | 5 |
| 65 | C4MH/TMPTA (10/90), | Hardwood | 1 | 1 |
| | 30% | | | |
| Control-18 | No coating | Hardwood | 5 | 5 |
| 66 | C4MH/906/HEA/A174 | Glass | 1 | 1 |
| | (5/85/10/1), 20% | | | |
| 67 | C4MH/TMPTA/A-174 | Glass | 1 | 1 |
| | (10/90/1), 20% | | | |
| Control-19 | No coating | Glass | 5 | 5 |

TABLE V
Contact Angle Data for Hardcoat Compositions on Different Substrates:

| | Coating Formulation | | | | | |
|---|---|---|---|---|---|---|
| | (Ratio by weight), | | Ad- | Rec | Ad- | Rec |
| Exp. No.# | solid % | Substrate | H₂O | H₂O | Oil | Oil |
| 68 | C4MH/906/A-174 | Ceramic | 119 | 80 | 66 | 56 |
| | (5/93/2), 30% | Tile | | | | |
| 69 | C4MH/906 (5/95), | Ceramic | 107 | 95 | 68 | 61 |
| | 30% | Tile | | | | |
| 70 | C4MH/906 (10/90), | Ceramic | 119 | 99 | 69 | 58 |
| | 30% | Tile | | | | |
| 71 | C4MH/TMPTA | Ceramic | 120 | 101 | 71 | 63 |
| | (5/95), 30% | Tile | | | | |
| 72 | C4MH/TMPTA | Ceramic | 121 | 102 | 71 | 62 |
| | (10/90), 30% | Tile | | | | |
| Control-20 | No coating | Ceramic | 56 | 26 | 43 | 18 |
| | | Tile | | | | |
| 73 | C4MH/906 (5/95), | Vinyl | 110 | 89 | 68 | 59 |
| | 30% | | | | | |
| 74 | C4MH/906 (5/95), | Vinyl | 114 | 83 | 68 | 59 |
| | 30% | | | | | |
| 75 | C4MH/906 (10/90), | Vinyl | 112 | 95 | 64 | 56 |
| | 30% | | | | | |
| 76 | C4MH/TMPTA | Vinyl | 109 | 96 | 73 | 64 |
| | (5/95), 30% | | | | | |
| 77 | C4MH/TMPTA | Vinyl | 113 | 97 | 69 | 60 |
| | (10/90), 30% | | | | | |
| 78 | C4MH/906 (5/95), | Aluminum | 114 | 95 | 68 | 62 |
| | 30% | metal | | | | |
| 79 | C4MH/906 (10/90), | Aluminum | 119 | 97 | 73 | 62 |
| | 30% | metal | | | | |
| 80 | C4MH/TMPTA | Aluminum | 119 | 99 | 73 | 64 |
| | (5/95), 30% | metal | | | | |
| 81 | C4MH/TMPTA | Aluminum | 120 | 99 | 73 | 62 |
| | (10/90), 30% | metal | | | | |
| 82 | C4MH/TMPTA | Hardwood | 117 | 94 | 62 | 52 |
| | (10/90), 30% | | | | | |

Similar to the results on PET, different hardcoat formulations with C4MH additive, on for different substrates also presented good marker repellent and contact angles for both water and hexadecane oil, as shown in Table IV and Table V.

For an easy cleaning hard coat, it can be advantageous for the coating to be resistant to solvent during cleaning with solvent-based cleaners. Solvent resistant testing was conducted for hardcoat compositions with C4MH additives, and the results are summarized in Table VI below.

TABLE VI
Solvent Resistance Test for C4MH Additive Coating on PET Film*

| | Coating Formulation | | | | | |
|---|---|---|---|---|---|---|
| | (Ratio by weight), | | | | | |
| Exp. No.# | solid % | Acetone | Toluene | Ethyl acetate | MIBK | IPA |
| 83 | C4MH/906 (1.5/98.5), | C/5 | C/5 | C/5 | C/5 | C/5 |
| | 30% | | | | | |
| 84 | C4MH/906 (2/98), 30% | C/5 | C/5 | C/5 | C/5 | C/5 |
| 85 | C4MH/906 (5/95), 30% | C/1 | C/1 | C/1 | C/1 | C/1 |
| 86 | C4MH/906 (10/90), 30% | C/1 | C/1 | C/1 | C/1 | C/1 |
| 87 | C4MH/906/P-36 | C/1 | C/1 | C/1 | C/1 | C/1 |
| | (5/95/0.5), 30% | | | | | |
| 88 | C4MH/906/P-36 | C/1 | C/1 | C/1 | C/1 | C/1 |
| | (5/95/1.5), 30% | | | | | |
| 89 | C4MH/TMPTA | C/3 | C/3 | C/3 | C/4 | C/3 |
| | (1.5/98.5), 30% | | | | | |
| 90 | C4MH/TMPTA (2/98), | C/1 | C/1 | C/1 | C/1 | C/1 |
| | 30% | | | | | |
| 91 | C4MH/TMPTA (5/95), | C/1 | C/1 | C/1 | C/1 | C/1 |
| | 30% | | | | | |
| 92 | C4MH/TMPTA (10/90), | C/1 | C/1 | C/1 | C/1 | C/1 |
| | 30% | | | | | |
| 93 | C4MH/TMPTA/P-36 | C/1 | C/1 | C/1 | C/1 | C/1 |
| | (5/95/0.5), 30% | | | | | |
| 94 | C4MH/TMPTA/P-36 | C/1 | C/1 | C/1 | C/1 | C/1 |
| | (5/95/1.5), 30% | | | | | |
| Control- | C4MH/ODA polymer | H/5 | H/5 | H/5 | H/5 | C/5 |
| 21 | (70/30) | | | | | |
| Control- | C4MH/PEGDA polymer | H/5 | SH/5 | H/5 | H/5 | C/5 |
| 22 | (90/10) | | | | | |

From Table VI, these highly crosslinked coatings resist the selected solvents without any change in appearance being observed. After the solvent is dried, the original marker resistant performance remained.

The durability of the coated PET film was studied with Steel Wool test. The results from four micron thickness coatings are summarized in Table VII and Table VIII, which show good mechanical durability.

TABLE VII
Wool Rubbing Test Results (on 1.25 inch stylus with 1000 g weight):

| | Coating Formulation | | Sharpie | | Sharpie Test |
|---|---|---|---|---|---|
| | (Ratio by weight), | 100 | Test after | | after 100 |
| Exp. No.# | solid % | Cycles | 100 cycles | 250 Cycles | cycles |
| 95 | C4MH/906 (5/95), 30% | NS | Yes | NS | Yes |
| 96 | C4MH/906/P-36 | NS | Yes | LS | Yes |
| | (5/95/1.5), 30% | | | | |
| 97 | C4MH/TMPTA (2/98), | NS | Yes | NS | Yes |
| | 30% | | | | |
| Control-23 | C4MH/PEGDA polymer | S | No | N/A | N/A |
| | (90/10), 5% | | | | |

NS: No visible scratch;
LS: Little scratched;
S: Scratched.

TABLE VIII
Contact Angles Before and After Steel Wool Test (on 1.25 inch stylus with
1000 g weight):

| | | Before steel wool | | After steel wool (250 cycle) | |
|---|---|---|---|---|---|
| | | H₂O Contact | Oil Contact | H₂O Contact | Oil Contact |
| Exp. | Coating Formulation | Angle Adv/Rec, | Angle | Angle Adv/Rec, | Angle |
| No.# | (Ratio by weight), solid % | Static (°) | Adv/Rec, (°) | Static (°) | Adv/Rec, (°) |
| 98 | C4MH/TMPTA (2/98), | 107/66, 94 | 57/44 | 105/62, 91 | 54/40 |
| | 30% | | | | |
| 99 | C4MH/906 (5/95), 30% | 107/71, 91 | 55/48 | 105/71, 92 | 58/50 |

These improvements in solvent resistance, marker repellency, and mechanical durability that are exhibited by at least some embodiments of the invention may be due at least in part by the degree of crosslinking degree in the hardcoat layers that are formed from compositions of the invention. Generally, such a degree of crosslinking is unattainable from non-UV cured polymerization processes. It has also been suggested that both high water/oil contact angles and good solvent resistance may help in achieving high marker repellency characteristics

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A hardcoat composition comprising:
i) at least one non-fluorinated crosslinking agent, and
ii) at least one fluoroacrylate having the formula:
R^{f3}-J-OC(O)NH—K—HNC(O)O—(C_{b}H_{2b})CH₍₃₋ᵥ₎((C_{y}H_{2y})OC(O)C(R⁸)═CH₂)ᵥ
wherein, R^{f3} is a monovalent perfluoroalkyl group or a polyfluoroalkyl group which can be linear, branched, or cyclic;
J is a divalent linkage group selected from: —SO2-N(R)—CₕH₂ₕ—, —C(O)—N(R)—CₕH₂ₕ—, —(CH₂)ₕ—, —O(CH₂)ₕ—, —(CH₂)ₕ—O—(CH₂)ⱼ—, or —(CH₂)ₕ—S—(CH₂)ⱼ—;
wherein R is H or an alkyl group of 1 to 4 carbon atoms;
h is 2 to 8;
j is 1 to 5;
K is the residue of a diisocyanate with an unbranched symmetric alkylene group, arylene group, or aralkylene group;
b is 1 to 30;
v is 1 to 3;
y is 0 to 6; and
R⁸ is H, CH₃, or F; and
iii) at least one initiator.

2. The hardcoat composition according to claim 1, wherein R^{f3} is CₑF₂ₑ₊₁, wherein e is 1 to 8; CF₃CF₂CF₂CHFCF₂—; CF₃CHFO(CF₂)₃—; (CF₃)₂NCF₂CF₂—; CF₃CF₂CF₂OCF₂CF₂—; CF₃CF₂CF₂OCHCF₂—; n-C₃F₇OCF(CF₃)—; H(CF₂CF₂)₃—; or n-C₃F₇OCF(CF₃)CF₂OCF₂—.

3. The hardcoat composition according to claim 2, wherein R^{f3} is CF₃CF₂CF₂CF₂— and CF₃CF₂CF₂CF₂CF₂CF₂—.

4. The hardcoat composition according to claim 1, wherein J is
—SO₂—N(R)—CₕH₂ₕ—.

5. The hardcoat composition according to claim 1, wherein J is
—SO₂—N(CH₃)—C₂H₄—.

6. The hardcoat composition according to claim 1, wherein K is
—(CH₂)₆—, —C₆H₄—CH₂—C₆H₄—, or —C₆H₄—.

7. The hardcoat composition according to claim 1, wherein the fluoroacrylate is C₄F₉SO₂N(CH₃)C₂H₄O—C(O)NHC₆H₅CH₂C₆H₅NHC(O)—OC₂H₄OC(O)CH═CH₂ (MeFBSE-MDI-HEA), C₄F₉SO₂N(CH₃)C₂H₄O—C(O)NH(CH₂)₆NHC(O)—OC₂H₄OC(O)Me═CH₂ (MeFBSE-HDI-HEMA), C₄F₉SO₂N(CH₃)C₂H₄O—C(O)NH(CH₂)₆NHC(O)—OC₄H₈OC(O)CH═CH₂ (MeFBSE-HDI-BA), C₄F₉SO₂N(CH₃)C₂H₄O—C(O)NH(CH₂)₆NHC(O)—OC₁₂H₂₄OC(O)CH═CH₂ (MeFBSE-HDI-DDA), CF₃CH₂O—C(O)NHC₆H₅CH₂C₆H₅NHC(O)—OC₂H₄OC(O)CH═CH₂ (CF₃CH₂OH-MDI-HEA), C₄F₉CH₂CH₂O—C(O)NHC₆H₅CH₂C₆H₅NHC(O)—OC₂H₄OC(O)CH═CH₂ (C₄F₉CH₂CH₂OH-MDI-HEA), C₆F ₁₃CH₂CH₂O—C(O)NHC₆H₅CH₂C₆H₅NHC(O)—OC₂H₄OC(O)CH═CH₂ (C₆F₁₃CH₂CH₂OH-MDI-HEA), C₃F₇CHFCF₂CH₂O—C(O)NHC₆H₅CH₂C₆H₅NHC(O)—OC₂H₄OC(O)CH═CH₂ (C₃F₇CHFCF₂CH₂OH-MDI-HEA), CF₃CHFO(CF₂)₃CH₂O—C(O)NHC₆H₅CH₂C₆H₅NHC(O)—OC₂H₄OC(O)CH═CH₂ (CF₃CHFO(CF₂)₃CH₂O-MDI-HEA), C₃F₇OCHFCF₂CH₂O—C(O)NHC₆H₅CH₂C₆H₅NHC(O)—OC₂H₄OC(O)CH═CH₂ (C₃F₇OCHFCF₂CH₂OH-MDI-HEA), C₃F₇OCF(CF₃)CH₂O—C(O)NHC₆H₅CH₂C₆H₅NHC(O)—OC₂H₄OC(O)CH═CH₂ (C₃F₇OCF(CF₃)CH₂OH-MDI-HEA), C₄F₉SO₂NMeC₂H₄O—C(O)NHC₆H₄CH₂C₆H₄NHC(O)—OCH₂C(CH₂OC(O)CH═CH₂)₃ (MeFBSE-MDI-(SR-444C)), or combinations thereof.

8. The hardcoat composition according to claim 1, wherein the non-fluorinated crosslinking agent is at least 20 wt % of the total weight of the hardcoat composition.

9. The hardcoat composition according to claim 1, wherein the non-fluorinated crossslinking agent is at least 50 wt % of the total weight of the hardcoat composition.

10. The hardcoat composition according to claim 1, wherein the fluroacrylate is from 1 to 40 wt % of the total weight of the hardcoat composition.

11. The hardcoat composition according to claim 1, wherein the fluroacrylate is from 2 to 10 wt % of the total weight of the hardcoat composition.

12. The hardcoat composition according to claim 1 further comprising surface modified inorganic particles.

13. A protective film comprising:
a substrate having a cured hardcoat layer comprising the reaction product of according to claim 1.

14. The protective film according to claim 13, wherein said hardcoat layer has a static contact angle of water that is greater than 70 degrees.

15. The protective film according to claim 13, wherein said hardcoat layer ahs a static contact angle of hexadecane that is greater than 50 degrees.

16. The protective film according to claim 13, wherein the substrate is vinyl, wood, textiles, fabrics, carpets, leather, paper, stone, glass, metals, ceramics, masonry, paint, plastics, or thermoplastic resins.

17. The protective film according to claim 13, wherein the substrate is an optical substrate.

18. An optical display comprising:
an optical substrate having a cured hardcoat layer comprising the reaction product of a hardcoat composition according to claim 1.

19. The optical display according to claim 18, wherein said hardcoat layer has a static contact angle of water that is greater than 70 degrees.

20. The optical display according to claim 18, wherein said hardcoat layer has a static contact angle of hexadecane that is greater than 50 degrees.

21. The optical display according to claim 20, wherein the hardcoat layer has a thickness of less than 25 microns.

22. A method of forming a hardcoat layer on a substrate comprising;
providing a hardcoat composition according to claim 1;
applying the hardcoat composition to a substrate;
removing at least a portion of the solvent; and
curing the hardcoat composition to form a hardcoat layer on the substrate.
